(19) United States
(12) Patent Application Publication
(10) Pub. No.: US 2003/0134141 A1
(43) Pub. Date: Jul. 17, 2003

(54) Crosshead bearing for marine engine

(76) Inventors: Atsushi Okado, Nagoya-shi (JP); Yuichi Tomita, Nagoya-shi (JP); Motohira Yamada, Nagoya-shi (JP); Hidehiko Tamura, Nagoya-shi (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/321,231

(22) Filed: Dec. 17, 2002

(30) Foreign Application Priority Data
Dec. 17, 2001 (JP) 2001-383052

(51) Int. Cl. B32B 15/08

(52) U.S. Cl. 428/626; 384/910; 384/909

(57) ABSTRACT

There is provided a crosshead bearing for a marine engine, comprising a bearing alloy layer, and a coating layer comprising a synthetic resin which is bonded onto the bearing alloy layer, and said coating may contain at least one kind selected from the group consisting of a solid lubricant, hard particles, and a metal powder.

### CROSS-REFERENCE TO RELATED APPLICATIONS

This application claims priority based on Japanese Application No. 2001-383052, filed Dec. 17, 2001.

### BACKGROUND OF THE INVENTION

The present invention relates to a crosshead bearing for a marine engine, which is used to support a crosshead pin for the marine engine.

In general, as an engine for driving a ship, there is used a two-cycle diesel engine of a large size. In this type engine, the crosshead bearing for supporting the crosshead pin is constituted by two semi-circular plain bearings abutted each other in the perpendicular direction.

In prior arts, a conventional crosshead bearing of this kind is provided, as shown in FIG. 4, with: a back metal layer 1 made of a steel; a bearing alloy layer 2, which is made of a Sn-based white alloy, bonded onto the inner face of the back metal layer; and a Pb-based or Sn-based overlay layer 3, which is provided for enhancing the anti-seizure property, bonded onto the face (sliding face) of the bearing alloy layer. Further, as shown in FIG. 5, there is another crosshead bearing in which an aluminum alloy is used as the material of the bearing alloy layer 4 for the purpose of enhancing the strength of the bearing. In this case, in order to make the bonding between the bearing alloy layer 4 and the overlay layer 3 good, an intermediate layer 5 made of Ag or Ni is provided between them. The intermediate layer 5 is provided on the bearing alloy layer 4 by plating.

### SUMMARY OF THE INVENTION

In this crosshead bearing, particularly the half bearing of the lower side thereof is always subjected to a large load from the crosshead pin during the use thereof. Further, because the motion of the crosshead pin is slow and because the motion thereof is not any rotation but an oscillation motion, it is difficult for an oil film to be provided between the sliding face of the bearing and the crosshead pin, and a considerable degree of heat is apt to occur. Thus, circumstances under which the crosshead bearing is used is severe, so that there is such a problem as the peeling-off of the overlay layer 3 is apt to occur due to the damage of the overlay layer 3 which is caused by the local contact thereof caused particularly in an initial stage of the use thereof, the confinement of foreign matters, and the occurrence of heat. In the case where the overlay layer 3 is peeled off, there occurs a metal-to-metal contact with the result that there occurs such a problem as the seizure of the bearing is apt to occur. Particularly, in the case of a bearing in which an aluminum alloy is used as the material of the bearing alloy layer 4, the intermediate layer 5 (, that is, hard Ag or Ni of which the intermediate layer 5 is made) comes to be exposed by the peeling-off of the overlay layer 3, which makes the seizure of the bearing more apt to occur.

The present invention is made in taking the above circumstances into consideration.

The object of the invention is to obtain a crosshead bearing for a marine engine which can enhance both of the wear resistance and the anti-seizure property while preventing the peeling-off of a coating layer from occurring.

According to the first aspect of the invention, there is provided a crosshead bearing for a marine engine, comprising a bearing alloy layer, and a coating layer comprising a synthetic resin, said coating layer being bonded onto the bearing alloy layer.

The coating layer made of the synthetic resin has a good conformability and superior friction-wear characteristics in comparison with an overlay layer made of a metal, so that it becomes possible to prevent the peeling-off of the coating layer from occurring and to enhance both of the wear resistance and the anti-seizure property.

It is preferred that the coating layer made of the synthetic resin contains at least one kind selected from the group consisting of a solid lubricant, hard particles, and a metal powder.

In the case where the solid lubricant is contained, the sliding characteristic of the sliding face of the bearing is further enhanced, so that it becomes possible to remarkably reduce the friction and wear thereof and to further enhance the wear resistance and the anti-seizure property.

In the case of the hard particles being contained, the wear resistance is further enhanced.

As regards the metal powder, the powder of a metal readily sulfurized is preferred. Since the readily sulfurized metal combines with sulfur component in a lubricant oil to thereby generate a sulfide having a lubrication property, it is possible to enhance the lubrication property of the bearing.

### BRIEF DESCRIPTION OF THE DRAWINGS

FIG. 1 is a partial cross sectional view of the crosshead bearing according to the embodiment of the invention;

FIG. 2 is a graph showing the result of the test relating to the friction coefficient;

FIG. 3 is a graph showing the results of the test relating to the amount of the wear;

FIG. 4 is a partial cross sectional view of a conventional crosshead bearing; and

FIG. 5 is a partial cross sectional view of another conventional crosshead bearing.

### DESCRIPTION OF THE PREFERRED EMBODIMENTS

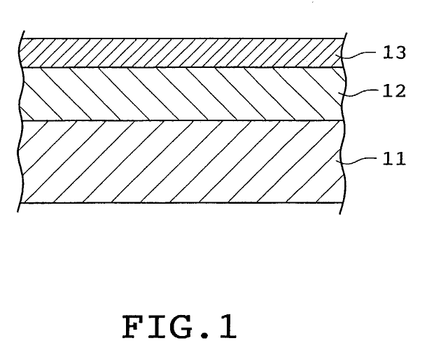

Embodiments of the invention are described below while referring to FIG. 1.

A crosshead bearing embodying the invention has, as shown in FIG. 1, a back metal layer 11 formed of a steel sheet having a thickness of 10.0 mm, a bearing alloy layer 12 made of an aluminum-based alloy containing about 40 mass % Sn, the bearing alloy layer 12 having a thickness of 1.0 mm being bonded onto the back metal layer by a roll-bonding method, and a coating layer 13 made of a synthetic resin, the coating layer being bonded onto the bearing alloy layer by a spray coating method. The coating layer 13 of the synthetic resin has a thickness of about 20 micron meters. The coating layer 13 consists of a synthetic resin which is used as a binder, and at least one kind selected from the group consisting of a solid lubricant, hard particles, and a metal powder.

As the synthetic resin used as the coating layer 13, there is used at least one kind selected from the group consisting of polyamide-imide resin (PAI), polybenzimidazole resin (PBI), polyamide resin (PA), epoxy resin (EP), and phenolic resin, and the content of the synthetic resin is preferably 30 to 95 volume %.

As the solid lubricant, there is used at least one kind selected from the group consisting of polytetrafluoroethylene resin (PTFE), MoS₂, graphite (Gr), boron nitride (BN), polyether-sulfon resin (PES), and the content thereof is preferably 5 to 70 volume %.

As the hard particles, there is used at least one kind selected from the group consisting of metal oxides (such as TiO₂, Al₂O₃ and etc.), carbides (such as WC, Mo₂C, SiC and etc.), and nitrides (such as Si₃N₄ and etc.), and the content thereof is preferably not more than 5 volume %.

As the metal powder, it is preferred to use a readily sulfurized metal such as Cu, Ag, and Zn etc, and the content thereof is preferably not more than 10 volume %.

In Table 1 shown below is disclosed the component of the coating layer regarding each of the products of Embodiments Nos. 1 to 12 of the invention. As the synthetic resin used as the binder, PAI resin is used in each of Embodiments Nos. 1 to 6 and 12, in each of Embodiments Nos. 7 to 9 and 11 being used PBI resin, and in Embodiment No. 10 is used EP resin. As the solid lubricant, PTFE resin is used in each of Embodiments Nos. 1 to 5, 7 to 10 and 12, MoS₂ being used in Embodiment No. 6, and Gr is used in Embodiment No. 11. As regards the hard particles, TiO₂ is used in each of Embodiments Nos. 1 to 4, 6, 10 and 12, Al₂O₃ being used in each of Embodiments Nos. 5 and 7, SiC being used in each of Embodiments Nos. 8 and 11, and Si₃N₄ is used in Embodiment No. 9. In Table 1, the unit of the numerical values in the columns of the solid lubricant and the hard particles is volume percent(%).

TABLE 1

| | | | | Solid Lubricant | | | | | | | |
|---|---|---|---|---|---|---|---|---|---|---|---|
| Kind of | Binder (Synthetic Resin) | | | (vol. %) | | | Hard Particles (vol. %) | | | | Crosshead test |
| Product | PAI | PBI | EP | M₀S₂ | Gr | PTFE | TiO₂ | Al₂O₃ | SiC | Si₃N₄ | (peeling-off) |
| Inventive Product | | | | | | | | | | | |
| Embodiment 1 | the Balance | | | | | 60 | 1 | | | | ∘ |
| Embodiment 2 | the Balance | | | | | 50 | 1 | | | | ∘ |
| Embodiment 3 | the Balance | | | | | 40 | 1 | | | | ∘ |
| Embodiment 4 | the Balance | | | | | 40 | 3 | | | | ∘ |
| Embodiment 5 | the Balance | | | | | 40 | | 3 | | | ∘ |
| Embodiment 6 | the Balance | | | 40 | | | 1 | | | | ∘ |
| Embodiment 7 | | the Balance | | | | 40 | | 3 | | | ∘ |
| Embodiment 8 | | the Balance | | | | 40 | | | 3 | | ∘ |
| Embodiment 9 | | the Balance | | | | 40 | | | | 3 | ∘ |
| Embodiment 10 | | | the Balance | | | 40 | 3 | | | | ∘ |
| Embodiment 11 | | the Balance | | | 40 | | | | 3 | | ∘ |
| Embodiment 12 | the Balance | | | | | 30 | 1 | | | | ∘ |
| Compara- | | | | | | | | | | | |
| tive | | | | | | | | | | | |
| Product | | | | | | | | | | | |
| Comparison 13 | | | | | | | | | | | x |
| Comparison 14 | | | | | | | | | | | x |

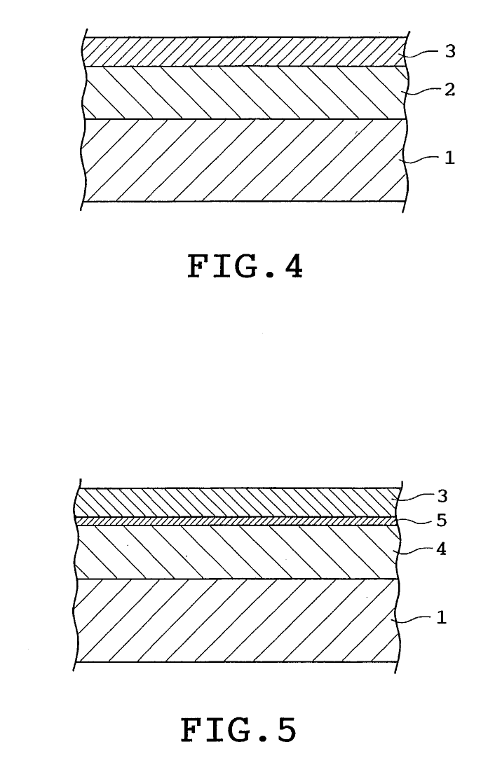

In Table 1, comparative products Nos. 13 and 14 correspond to conventional ones, and comparative product No. 13 corresponds to the conventional one shown in FIG. 5 which has an overlay layer 3 of a Pb-based alloy bonded to a bearing alloy layer through an intermediate layer 5 of Ni. Comparative product No. 14 corresponds to the conventional one shown in FIG. 4 which has an overlay layer 3 of a Pb-based alloy bonded to a bearing alloy layer made of a white alloy.

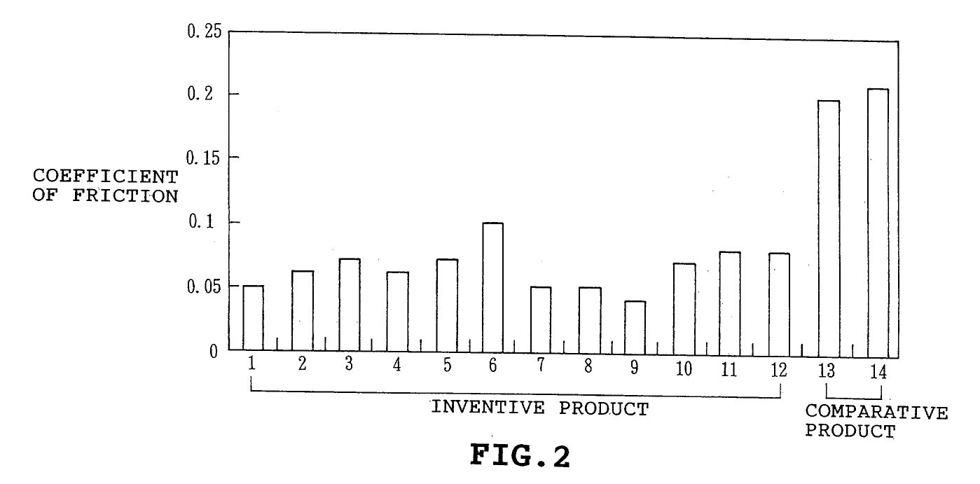

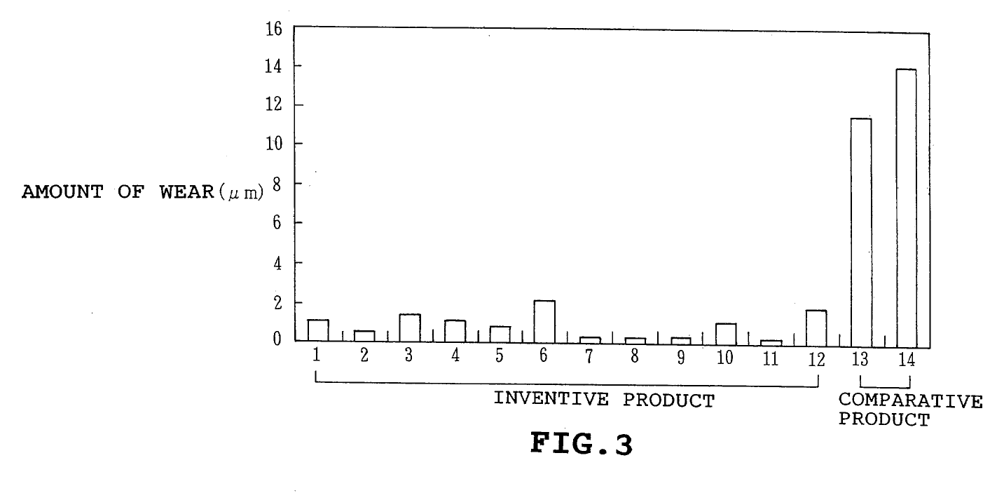

By use of these products was performed a friction-wear test, the results of which are shown in FIGS. 2 and 3. In the friction-wear test, a thrust type friction-wear testing machine was used under the test conditions shown in Table 2, by use of which the friction coefficient and the amount of the wear were measured.

TABLE 2
Friction-Wear Test Condition

| Item | Test condition | unit |
|---|---|---|
| Size of test piece | Outer diameter 27.2 × | mm |
| | Inner diameter 22.0 | |
| Rotation Speed | 8 | rpm |
| Peripheral Speed | 0.01 | m/sec |
| Specific load | 8.8 (constant) | MPa |
| Lubricant | SAE #30 | — |
| Temperature of lubricant | Room temperature | ° C. |
| Lubricating method | Oil bath | ml/min |
| Material of Shaft | S55C | — |
| Shaft roughness | not more than 1 | Rmax |
| Shaft hardness | 550-600 | Hv10 |
| Time for test | 4 | Hrs |

Regarding the friction coefficient, although the value thereof relating to each of comparative products Nos. 13 and 14 was, as apparent from FIG. 2, not less than 0.2, the values thereof relating to most of the products of embodiments Nos. 1 to 12 were not more than 0.10. Namely, it is apparent that the sliding characteristic regarding each of the products of embodiments Nos. 1 to 12 is superior to those of comparative Samples Nos. 13 and 14. As regards the amount of wear, although comparative products Nos. 13 and 14 revealed the values not less than 11 micron meters, each of the products of embodiments Nos. 1 to 12 revealed the value not more than 2 micron meters. Thus, it is apparent that the wear resistance of each of the products of embodiments Nos. 1 to 12 is superior to those of comparative products Nos. 13 and 14.

Further, regarding each of the products, the crosshead test was performed to observe whether or not the peeling-off of the coating layer occurred, the results thereof being shown in the right-hand end of Table 1. In the crosshead test, a lubricant oil was applied onto the inner face of the bearing, and this test was performed for one hour under a specific load corresponding to that of an actual crosshead.

In table 1, the mark “x” indicates that the peeling-off occurred, and the mark “o” indicates that no peeling-off occurred. As apparent from the results in Table 1, the state of seizure was locally observed by inspecting the sliding face after the test of each of comparative products No.s 13 and 14, however, in the products of embodiments Nos. 1 to 12 of the invention no abnormality was observed on the sliding faces thereof.

Thus, according to the products of embodiments Nos. 1 to 12 of the invention, the occurrence of the peeling-off of the coating layer can be prevented in the crosshead bearing by providing the coating layer 13 of the synthetic resin on the bearing alloy layer 12 of the crosshead bearing, and at the same time it becomes possible to enhance the wear resistance and the anti-seizure property thereof.

The invention is not limited to the embodiments described above and can be modified or expanded to ones recited below.

As regards the bearing alloy layer, a white alloy may be used instead of the aluminum-based alloy. The coating layer 13 may be made of a simple substance of a synthetic resin.

What is claimed is:

1. A crosshead bearing for a marine engine, comprising a bearing alloy layer, and a coating layer comprising a synthetic resin, said coating layer being bonded onto the bearing alloy layer.

2. A crosshead bearing according to claim 1, wherein said coating layer consists of said synthetic resin and at least one kind selected from the group consisting of a solid lubricant, hard particles, and a metal powder.

3. A crosshead bearing for a marine engine, comprising: a steel back metal layer; a bearing alloy layer bonded onto the steel back metal layer; and a coating layer made of a mixture of both of a synthetic resin not less than 30 volume % but not more than 95 volume % and at least one kind selected from the group consisting of a solid lubricant not less than 5 volume % but not more than 70 volume %, hard particles not more than 5 volume %, and a metal powder not more than 10 volume %, said coating layer being bonded onto the bearing alloy layer.

4. A crosshead bearing according to claim 3, wherein said synthetic resin is at least one kind selected from the group consisting of polyamide-imide resin, polybenzimidazole resin, polyamide resin, epoxy resin, and phenolic resin, said solid lubricant being at least one kind selected from the group consisting of polytetrafluoroethylene resin, MoS₂, graphite, BN, polyether-sulfon resin, said hard particles being at least one kind selected from the group consisting of a metal oxide, a carbide and a nitride, said metal powder being made of at least one kind selected from the group consisting of copper, silver and zinc.

5. A crosshead bearing according to claim 3, wherein said hard particles is ones of one kind selected from the group consisting of TiO₂, Al₂O₃, SiC, and Si₃N₄.
